(19) United States
(12) Patent Application Publication
(10) Pub. No.: US 2024/0288956 A1
(43) Pub. Date: Aug. 29, 2024

(54) STYLUS

(71) Applicant: SONY SEMICONDUCTOR SOLUTIONS CORPORATION, KANAGAWA (JP)

(72) Inventor: RYOJI EKI, KANAGAWA (JP)

(21) Appl. No.: 18/693,253

(22) PCT Filed: Aug. 16, 2022
(86) PCT No.: PCT/JP2022/030941

§ 371 Date: Mar. 19, 2024

(30) Foreign Application Priority Data
Oct. 1, 2021 (JP) 2021-162898

(51) Int. Cl. G06F 3/0354; G01J 3/36; G01J 3/46

(52) U.S. Cl. CPC G06F 3/03545; G01J 3/36; G01J 3/46

(57) ABSTRACT

A stylus includes a first sensor that has sensitivity to visible light, and a second sensor that obtains information regarding a shape of an object.

### TECHNICAL FIELD

The present technology relates to a stylus capable of obtaining information regarding an object.

### BACKGROUND ART

Some styluses as input tools have a configuration capable of extracting attribute information of an object.

For example, a stylus disclosed in Patent Document 1 is capable of obtaining color information as attribute information of an object.

By using such a stylus, it becomes possible to easily create a picture in which the color of the object is reproduced.

### CITATION LIST

### Patent Document

Patent Document 1: U.S. Patent Application Publication No. 2020/0225778

### SUMMARY OF THE INVENTION

### Problems to be Solved by the Invention

Meanwhile, even if a picture is drawn using only color information of an object, it is difficult to draw a picture resembling the object.

The present technology has been conceived in view of the problem described above, and aims to propose a stylus for drawing a picture in which attribute information of an object is more reflected.

### Solutions to Problems

A stylus according to the present technology includes a first sensor that has sensitivity to visible light, and a second sensor that obtains information regarding a shape of an object.

With this arrangement, it becomes possible to obtain information regarding not only color but also texture of an object OB.

### BRIEF DESCRIPTION OF DRAWINGS

FIG. 1 is a view illustrating a state of obtaining attribute information of an object using a stylus according to the present technology.

FIG. 2 is a view illustrating a state of drawing a picture using a drawing line reflecting the attribute information of the object.

FIG. 3 is a schematic cross-sectional view of a pen tip portion of the stylus.

FIG. 4 is a diagram illustrating a state where light reflected by the object is incident on a sensor.

FIG. 5 is a block diagram illustrating a functional configuration of a stylus according to a first embodiment.

FIG. 6 is a view illustrating a state where the attribute information extracted from the object is reflected in a painting attribute of a predetermined area.

FIG. 7 is a block diagram illustrating a functional configuration of a control unit of the stylus according to the first embodiment.

FIG. 8 is a flowchart illustrating a flow of a process to be executed by the control unit of the stylus according to the first embodiment.

FIG. 9 is a diagram illustrating a state where light reflected by an object is incident on a stylus according to a second embodiment.

FIG. 10 is a block diagram illustrating a functional configuration of the stylus according to the second embodiment.

FIG. 11 is a block diagram illustrating a functional configuration of a control unit of the stylus according to the second embodiment.

FIG. 12 is a flowchart illustrating a flow of a process to be executed by the control unit of the stylus according to the second embodiment.

FIG. 13 is a block diagram illustrating a functional configuration of a control unit of a stylus according to a third embodiment.

FIG. 14 is a block diagram illustrating a functional configuration of a control unit of a tablet terminal according to the third embodiment.

FIG. 15 is a flowchart illustrating a flow of a process to be executed by the control unit of the stylus according to the third embodiment.

FIG. 16 is a flowchart illustrating a flow of a process to be executed by the control unit of the tablet terminal according to the third embodiment.

FIG. 17 is a block diagram illustrating a functional configuration of a control unit of a stylus according to a fifth embodiment.

FIG. 18 is a flowchart illustrating a flow of a process to be executed by a control unit of a multispectral AI sensor according to the fifth embodiment.

FIG. 19 is a flowchart illustrating a flow of a process to be executed by a control unit of a polarization sensor according to the fifth embodiment.

FIG. 20 is a flowchart illustrating a flow of a process to be executed by the control unit of the stylus according to the fifth embodiment.

FIG. 21 is a flowchart illustrating a flow of a process to be executed by a control unit of a tablet terminal according to the fifth embodiment.

FIG. 22 is a schematic cross-sectional view of a pen tip portion of a stylus according to a sixth embodiment.

FIG. 23 is a block diagram illustrating a functional configuration of the stylus according to the sixth embodiment.

FIG. 24 is a diagram illustrating an exemplary pixel arrangement of a pixel array according to the sixth embodiment.

FIG. 25 is a diagram illustrating a Z pixel serving as a divided pixel according to the sixth embodiment.

FIG. 26 is a diagram illustrating the Z pixel serving as a light-shielding pixel according to the sixth embodiment.

FIG. 27 is a view illustrating an exemplary case where a pen tip of a stylus has a non-flat structure.

FIG. 28 is a view illustrating an exemplary case where a slit is provided at the pen tip of the stylus.

FIG. 29 is a view illustrating an exemplary case where a condenser lens is provided at the pen tip of the stylus.

### MODE FOR CARRYING OUT THE INVENTION

Hereinafter, embodiments will be described in the following order with reference to the accompanying drawings.
<1. Stylus Usage Mode>
<2. Stylus Configuration>
<3. Processing Flow>
<4. Second Embodiment>
<5. Third Embodiment>
<6. Fourth Embodiment>
<7. Fifth Embodiment>
<8. Sixth Embodiment>
<9. Variations>
<10. Conclusion>
<11. Present Technology>

### 1. Stylus Usage Mode

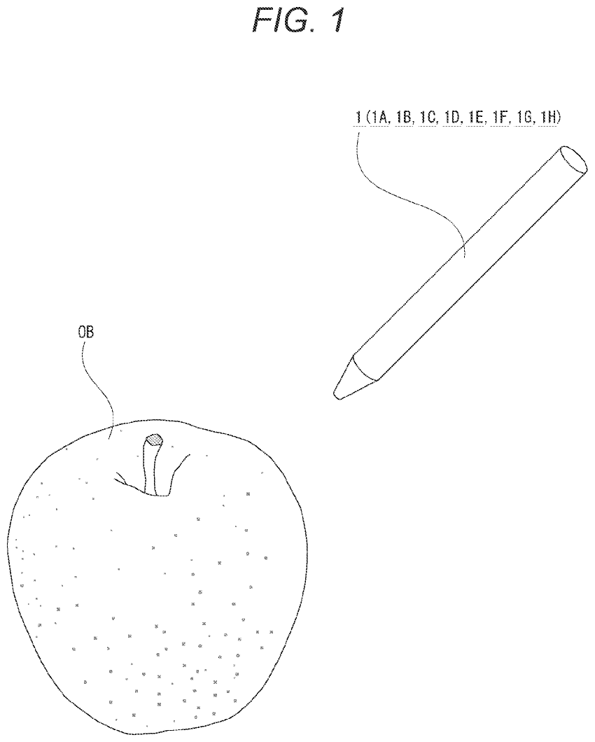

FIG. 1 is a view illustrating a state of obtaining attribute information of an apple as an object OB using a stylus 1 according to the present embodiment.

The stylus 1 is, for example, an elongated pen type, and is capable of obtaining attribute information of the object OB by bringing a pen tip close to the object OB. Note that the object OB is an object from which the attribute information is to be extracted.

The attribute information of the object OB is, for example, color information, texture information, or the like. The texture information is information such as a degree of smoothness or roughness of the surface of the object OB, and is, for example, information regarding unevenness of the surface of the object OB.

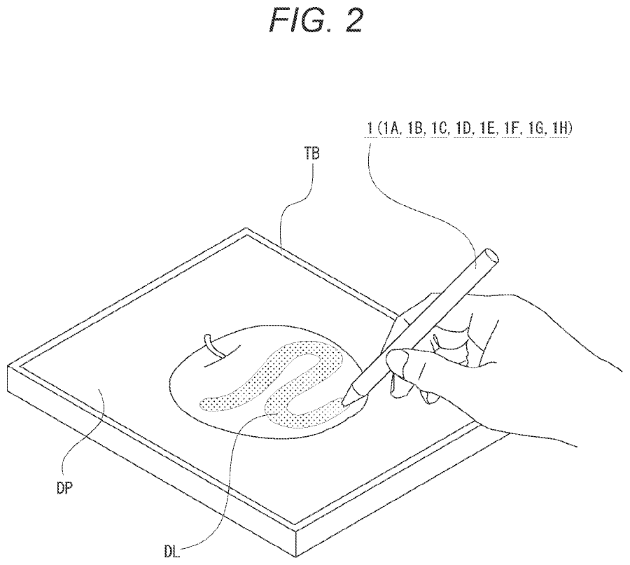

FIG. 2 is a view illustrating a state of drawing a picture of an apple using a drawing line DL reflecting the attribute information of the object OB obtained as illustrated in FIG. 1 by sliding the pen tip of the stylus 1 on a display unit DP of a tablet terminal TB.

In this manner, it becomes possible to implement two functions including the function of extracting the attribute information of the object OB using the stylus 1 and the function of drawing a picture using the drawing line DL reflecting the attribute information.

### 2. Stylus Configuration

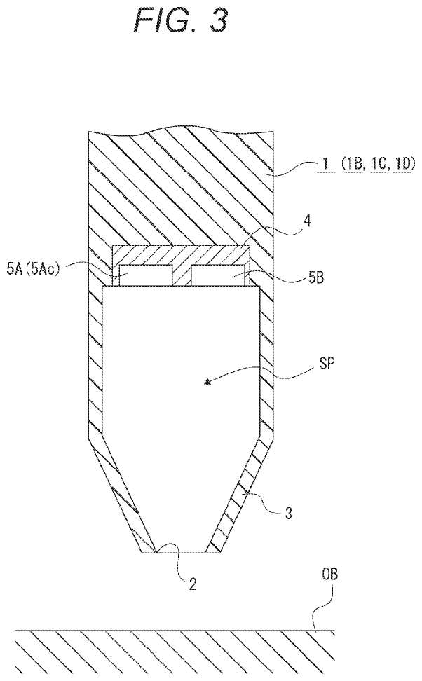

FIG. 3 illustrates a schematic cross-sectional view of the vicinity of the pen tip of the stylus 1 according to the first embodiment.

The stylus 1 includes a housing 3 having an opening 2 opened at one end and an internal space SP, and a sensor unit 4 disposed in the internal space SP.

The sensor unit 4 includes one or a plurality of sensors 5, a control unit that performs signal processing on signals output from the sensors 5, and a storage unit.

The sensor 5 includes a light receiving element that receives light incident through the opening 2.

Specifically, the sensor 5 includes a pixel array in which pixels having light receiving elements are two-dimensionally arranged, a read processing unit, and the like.

As illustrated in FIG. 3, the sensor unit 4 according to the present embodiment includes a first sensor 5A and a second sensor 5B. Note that the sensor unit 4 is conceptual, and each of the first sensor 5A and the second sensor 5B may be provided as a separate unit.

The first sensor 5A is a sensor that obtains color information of the object OB, and is, for example, a Red, Green, Blue (RGB) sensor.

The RGB sensor has a configuration in which an on-chip microlens, a color filter, a photoelectric conversion element, a wiring layer, and the like are stacked. Each pixel is one of an R pixel that receives red (R) light, a G pixel that receives green (G) light, or a B pixel that receives blue (B) light.

Note that the first sensor 5A may include a white (W) pixel, a yellow (Y) pixel, a magenta (Mg) pixel, and a cyan (Cy) pixel in addition to or instead of the R pixel, the G pixel, and the B pixel.

The second sensor 5B is a sensor that obtains texture information of the object OB, and is, for example, a polarization sensor. The polarization sensor has a configuration in which an on-chip microlens, a color filter, a polarizer, a photoelectric conversion element, a wiring layer, and the like are stacked.

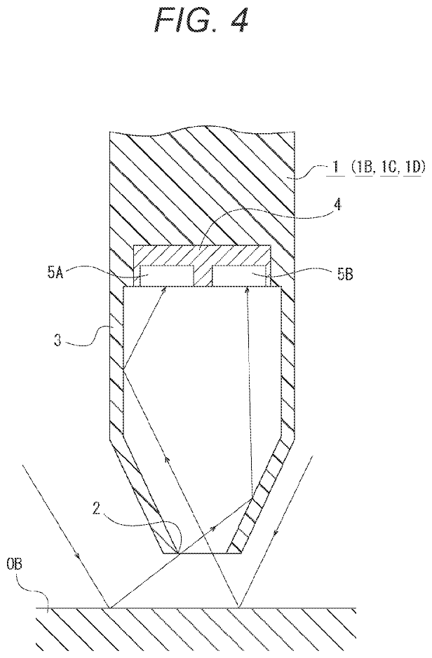

FIG. 4 illustrates a state where light is incident on each of the sensors 5.

As illustrated in the drawing, light reflected by the surface of the object OB is incident on the first sensor 5A and the second sensor 5B. Note that the light reflected by the object OB may be reflected by a wall portion of the internal space SP before entering each of the sensors 5.

As a result, the first sensor 5A is enabled to obtain color information of the object OB, and the second sensor 5B is enabled to obtain polarization information of the object OB. By obtaining the polarization information, the second sensor 5B is enabled to obtain information regarding the unevenness of the object OB, in other words, information regarding the texture.

Note that the first sensor 5A of the sensor unit 4 functions as a color detection unit and a color information acquisition unit that obtains information regarding colors.

In addition, the second sensor 5B of the sensor unit 4 functions as a texture detection unit and a texture acquisition unit that obtains information regarding texture.

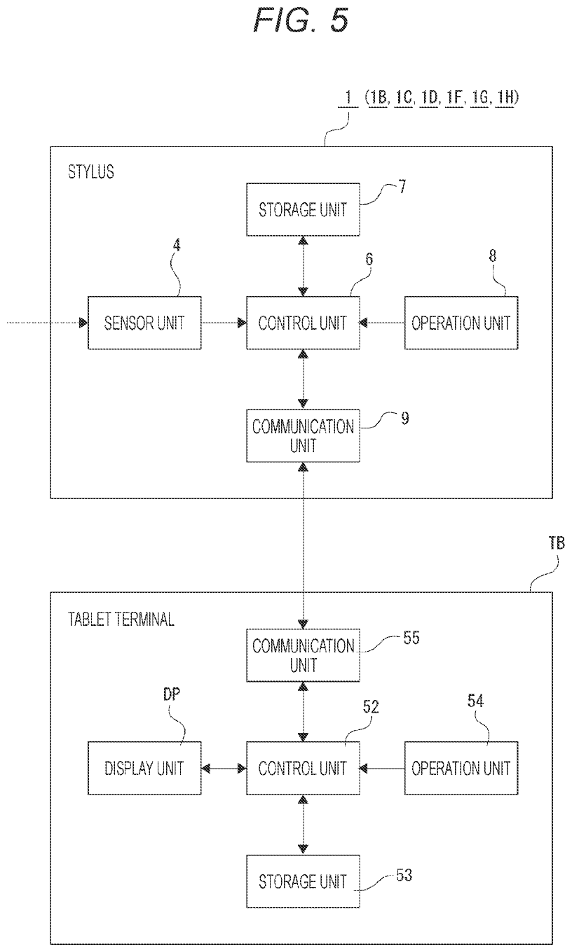

Functional configurations of the stylus 1 and the tablet terminal TB are illustrated in a block diagram (FIG. 5).

The stylus 1 includes the sensor unit 4, a control unit 6, a storage unit 7, an operation unit 8, and a communication unit 9.

The control unit 6 includes a central processing unit (CPU) and a graphics processing unit (GPU), performs various types of image processing on the basis of individual pixel signals output from the first sensor 5A and the second sensor 5B of the sensor unit 4, and extracts attribute information associated with the object OB. At this time, the control unit 6 may perform processing for canceling parallax between the two sensors 5.

Some of those kinds of processing to be executed by the control unit 6 may be carried out by a signal processing unit included in the first sensor 5A or the second sensor 5B.

The control unit 6 performs various types of processing according to operation signals output from the operation unit 8 provided on the stylus 1 as a button or the like. For example, in a case where the attribute information of the object OB is configured to be obtained while the button as the operation unit 8 is being processed, processes of extracting the attribute information on the basis of pixel signals output from the sensor unit 4 are executed while the operation signals from the operation unit 8 are being received, and those processes are not executed while no operation signal is received.

Alternatively, processing of transmitting the attribute information extracted from the object OB to the tablet terminal TB may be executed with the processing of the operation unit 8, such as a button, as a trigger.

Note that such an operation unit 8 is not an essential configuration for the stylus 1.

The storage unit 7 includes a read only memory (ROM), a random access memory (RAM), and the like, and stores programs and data to be used for processing to be executed by the control unit 6.

Furthermore, in the present example, the storage unit 7 also stores information required to extract the attribute information from the pixel signals output from the first sensor 5A and the second sensor 5B, and the like.

For example, in a case of specifying a material of the object OB by matching the polarization information obtained from the signals output from the second sensor 5B as the polarization sensor with the polarization information serving as a reference for each material, the polarization information serving as the reference for each material is stored in the storage unit 7 as reference data.

The communication unit 9 performs wired or wireless data communication with the tablet terminal TB. Specifically, the communication unit 9 performs processing of transmitting, to the tablet terminal TB, the attribute information extracted by the control unit 6 for the object OB, processing of receiving instruction information from the tablet terminal TB, and the like.

For example, in a case of executing processing of obtaining the attribute information in the stylus 1 in response to a user operation performed on the tablet terminal TB, the communication unit 9 receives the instruction information transmitted from the tablet terminal TB in response to detection of the user operation by the tablet terminal TB.

The tablet terminal TB includes a display unit DP, a control unit 52, a storage unit 53, an operation unit 54, and a communication unit 55.

The display unit DP is, for example, a display device such as a liquid crystal display (LCD), an organic electro-luminescence (EL) display, or the like.

The display device provided as the display unit DP is equipped with a touch panel function to receive an input operation according to a movement of the pen tip of the stylus 1 or a movement of a fingertip of a user.

The control unit 52 includes a CPU and a GPU, and performs overall control of the tablet terminal TB. For example, it performs processing of starting an operating system (OS) when power is turned on, processing of starting and ending various kinds of software, processing of detecting an operation performed on the operation unit 54, processing corresponding thereto, and the like.

Furthermore, the control unit 52 according to the present embodiment performs processing of setting attribute information of a drawing line and attribute information of painting on the basis of the attribute information received from the stylus 1.

For example, attribute information of a line drawn according to a locus of the pen tip of the stylus 1 is set according to the attribute information of the object OB obtained by the stylus 1.

As a result, as illustrated in FIG. 2, a drawing line reflecting the attribute information of the object OB is displayed on the display unit DP according to the movement locus of the stylus 1.

Alternatively, the attribute information of painting of an area designated by the pen tip of the stylus 1 may be set according to the attribute information of the object OB obtained by the stylus 1.

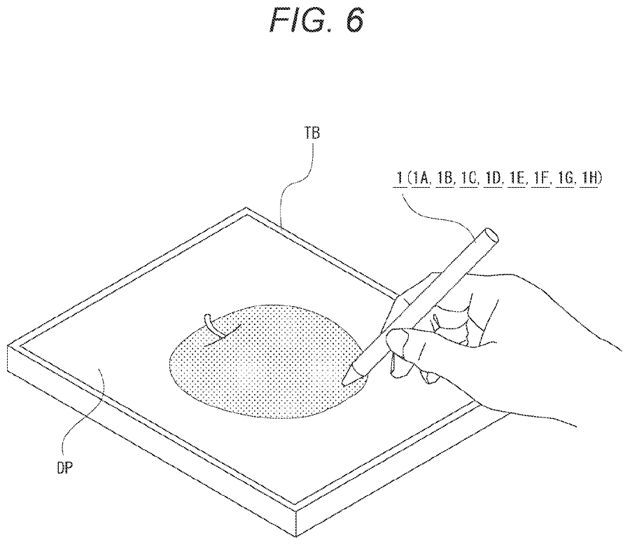

With this arrangement, as illustrated in FIG. 6, the attribute information extracted from the object OB is reflected in the painting attribute of the area surrounded by the outline indicating the apple.

The storage unit 53 includes a ROM, a RAM, a removable storage medium, and the like. The removable storage medium is, for example, a magnetic disk, an optical disk, a magneto-optical disk, a semiconductor memory, or the like.

The storage unit 53 stores programs and data to be used for processing to be executed by the control unit 52.

Furthermore, in the present example, the storage unit 53 stores the attribute information received from the stylus 1.

The operation unit 54 includes various manipulation elements such as a power switch. Furthermore, as described above, the display unit DP also functions as the operation unit 54.

The communication unit 55 performs wired or wireless data communication with the stylus 1.

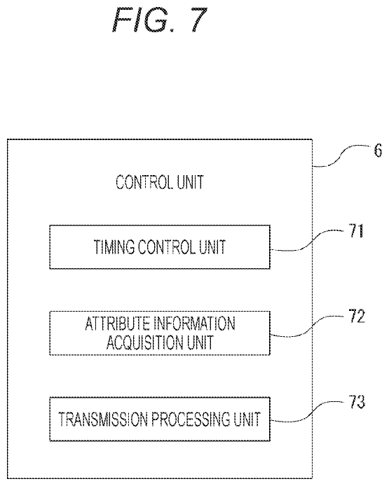

FIG. 7 is a block diagram illustrating functions to be implemented by the control unit 6 of the stylus 1.

The control unit 6 of the stylus 1 has functions as a timing control unit 71, an attribute information acquisition processing unit 72, and a transmission processing unit 73.

The timing control unit 71 controls timing for obtaining the attribute information of the object OB using the stylus 1. For example, the acquisition of the attribute information may be started at timing when a predetermined operation unit 8 is operated, or the acquisition of the attribute information may be started at timing when a distance between the pen tip of the stylus 1 and the object OB becomes less than a predetermined distance.

Alternatively, the timing control unit 71 may control the timing to obtain the attribute information every fixed time (e.g., several tens of msec or several hundred msec) regardless of the condition.

The attribute information acquisition processing unit 72 obtains the attribute information on the basis of pixel signals output from the sensor unit 4. Specifically, color information of the object OB is obtained by image processing performed on a pixel signal output from the first sensor 5A, and unevenness information of the object OB is obtained by image processing performed on a pixel signal output from the second sensor 5B.

Here, several examples of the unevenness information to be obtained by the attribute information acquisition processing unit 72 may be considered.

For example, several patterns of unevenness may be stored in the storage unit 7 in advance, and characteristics of the pixel signal output from the second sensor 5B may be applied to the characteristics of the unevenness patterns stored in the storage unit 7 to obtain the unevenness pattern of the object OB.

Alternatively, a pitch between recesses and a pitch between protrusions in an uneven shape, a height difference between a recess and a protrusion, a shape of a recess and a shape of a protrusion, and the like may be analyzed on the basis of the pixel signal output from the second sensor 5B to obtain the unevenness information of the object OB.

Furthermore, an uneven shape such as a scratch, a stain, or the like on the object OB may be obtained as the unevenness information on the basis of the pixel signal output from the second sensor 5B.

The transmission processing unit 73 performs processing of transmitting, to the tablet terminal TB, the attribute information such as the color information, the unevenness information, and the like obtained for the object OB.

### 3. Processing Flow

A flow of a process to be executed by the control unit 6 of the stylus 1 will be described with reference to FIG. 8.

In step S101, the control unit 6 determines whether or not the timing for obtaining the attribute information has come. In this processing, as described above, it is determined whether or not the pressing of the predetermined operation unit 8 or the approach of the pen tip of the stylus 1 to the object OB has been detected.

In step S102, the control unit 6 obtains the color information of the object OB on the basis of the pixel signal of the first sensor 5A.

In step S103, the control unit 6 obtains the unevenness information of the object OB on the basis of the pixel signal of the second sensor 5B.

In step S104, the control unit 6 collectively transmits, to the tablet terminal TB, the obtained color information and unevenness information as the attribute information of the object OB.

As a result, the attribute information extracted from the object OB is set as the attribute information in the drawing using the tablet terminal TB.

### 4. Second Embodiment

A stylus 1A according to a second embodiment includes a time of flight (ToF) sensor as a second sensor 5B. In addition, the stylus 1A includes a light emitting unit along with the ToF sensor.

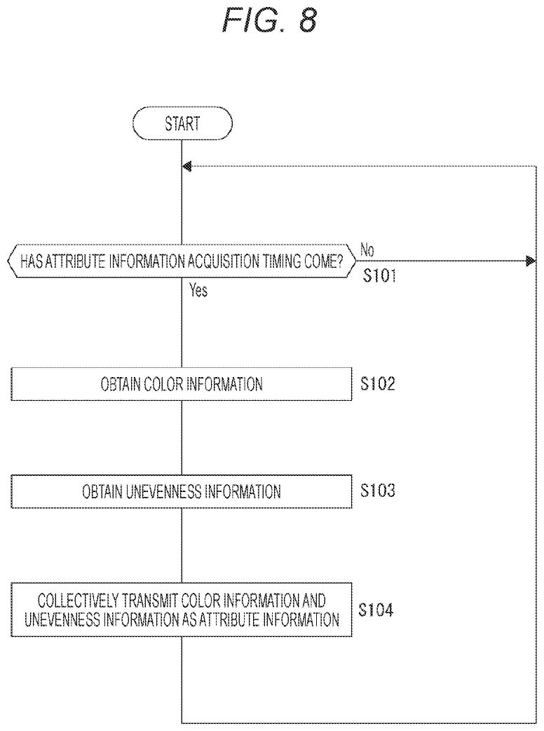

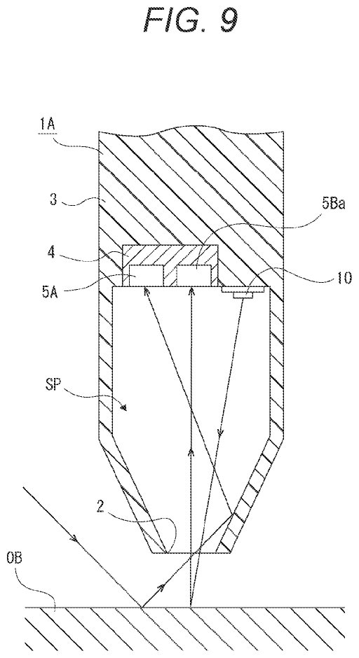

Specifically, as illustrated in FIG. 9, the stylus 1A includes a housing 3 having an opening 2 and an internal space SP, a sensor unit 4 disposed in the internal space SP, and a light emitting unit 10.

The sensor unit 4 includes one or a plurality of sensors 5, a control unit that performs signal processing on signals output from the sensors 5, and a storage unit.

The sensor 5 includes a light receiving element that receives light incident through the opening 2.

Specifically, the sensor 5 includes a pixel array in which pixels having light receiving elements are two-dimensionally arranged, a read processing unit, and the like.

The sensor unit 4 according to the present embodiment includes a first sensor 5A such as an RGB sensor, and a ToF sensor 5Ba as a second sensor 5B. Note that the sensor unit 4 is conceptual, and each of the first sensor 5A and the ToF sensor 5Ba may be provided as a separate unit.

The ToF sensor 5Ba is a sensor capable of measuring a distance by an indirect ToF (iToF) method or a direct ToF (dToF) method, and has sensitivity for IR light.

The light emitting unit 10 includes a light emitting diode (LED) or the like capable of emitting infrared (IR) light in accordance with light receiving sensitivity of the ToF sensor 5Ba.

The light emitting unit 10 and the ToF sensor 5Ba are capable of measuring a distance to an object OB by controlling light emission and light reception (reading) at predetermined timing.

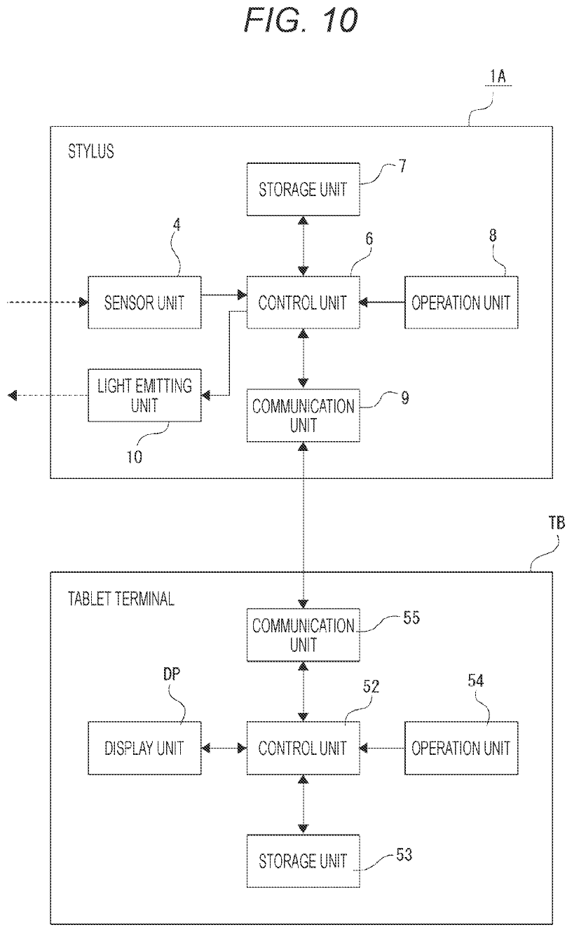

Specific functional configurations of the stylus 1A and the tablet terminal TB are illustrated in a block diagram (FIG. 10). Note that configurations similar to those in FIG. 5 are denoted by the same reference numerals, and descriptions thereof are omitted as appropriate.

The stylus 1A includes the sensor unit 4, a control unit 6, a storage unit 7, an operation unit 8, a communication unit 9, and the light emitting unit 10.

The control unit 6 is capable of appropriately obtaining distance information to the object OB by performing light emission control of the light emitting unit 10 and read control of the sensor unit 4 in synchronization with each other.

A configuration of the tablet terminal TB is similar to that of FIG. 6.

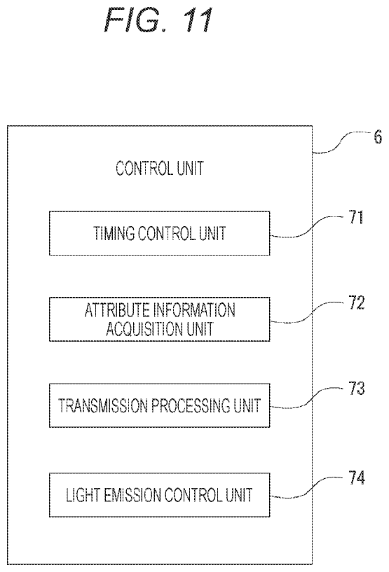

FIG. 11 is a block diagram illustrating functions to be implemented by the control unit 6 of the stylus 1A.

The control unit 6 of the stylus 1A has functions as a timing control unit 71, an attribute information acquisition processing unit 72, a transmission processing unit 73, and a light emission control unit 74.

The timing control unit 71 controls timing for obtaining attribute information of the object OB.

The attribute information acquisition processing unit 72 obtains color information and distance information as attribute information on the basis of pixel signals output from the sensor unit 4. Furthermore, unevenness information of the object OB may be extracted on the basis of the distance information.

The transmission processing unit 73 transmits, to the tablet terminal TB, the color information and the distance information (or unevenness information) obtained for the object OB.

The light emission control unit 74 controls light emission of the light emitting unit 10 in synchronization with the read control of the pixel signals in the sensor unit 4.

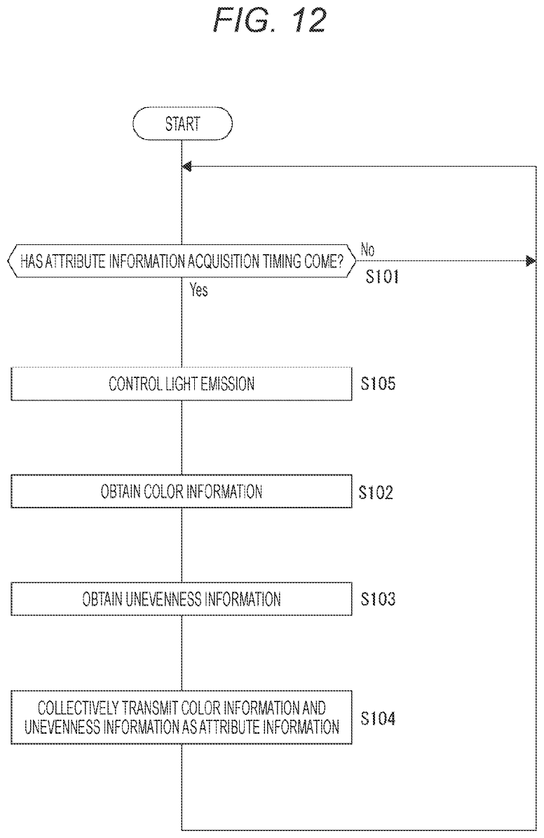

A flow of a process to be executed by the control unit 6 of the stylus 1A according to the second embodiment will be described with reference to FIG. 12.

In step S101, the control unit 6 determines whether or not the timing for obtaining the attribute information has come. In a case where the timing is not determined to have come, the control unit 6 performs the processing of step S101 again. Note that the light emission control of the light emitting unit 10 may be stopped while the processing of step S101 is repeatedly executed.

In a case where the timing for obtaining the attribute information is determined to have come, the control unit 6 starts the light emission control in step S105.

In step S102, the control unit 6 obtains the color information of the object OB on the basis of the pixel signal of the first sensor 5A.

In step S103, the control unit 6 obtains the unevenness information (which may be the distance information) of the object OB on the basis of a pixel signal of the ToF sensor 5Ba.

In step S104, the control unit 6 collectively transmits, to the tablet terminal TB, the obtained color information and unevenness information as the attribute information of the object OB.

As a result, the attribute information extracted from the object OB is set as the attribute information in the drawing using the tablet terminal TB.

The stylus 1A according to the second embodiment includes the light emitting unit 10 so that the ToF sensor 5Ba is enabled to appropriately obtain ranging information. Therefore, it becomes possible to obtain the unevenness information of the object OB, whereby the attribute information of the object OB may be reflected in a drawing line or the like.

Note that the stylus 1 according to the first embodiment may be provided with the light emitting unit 10. With the light emitting unit 10 provided, it becomes possible to secure a sufficient light amount for obtaining the attribute information of the object OB even in a state where the pen tip of the stylus 1 is in contact with the object OB.

Note that a ranging sensor other than the ToF method may be included as the second sensor 5B according to the second embodiment. Specifically, a sensor using a light detection and ranging (LiDAR) method, a sensor using a radio detecting and ranging (RADAR) method, or the like may be included as the second sensor 5B.

### 5. Third Embodiment

A stylus 1B according to a third embodiment is configured not to execute a part of the process described above. Those processes not executed by the stylus 1B are executed by a tablet terminal TB.

Configurations of the stylus 1B and the tablet terminal TB are similar to the configurations of the stylus 1 and the tablet terminal TB illustrated in FIG. 5, and thus illustration thereof is omitted.

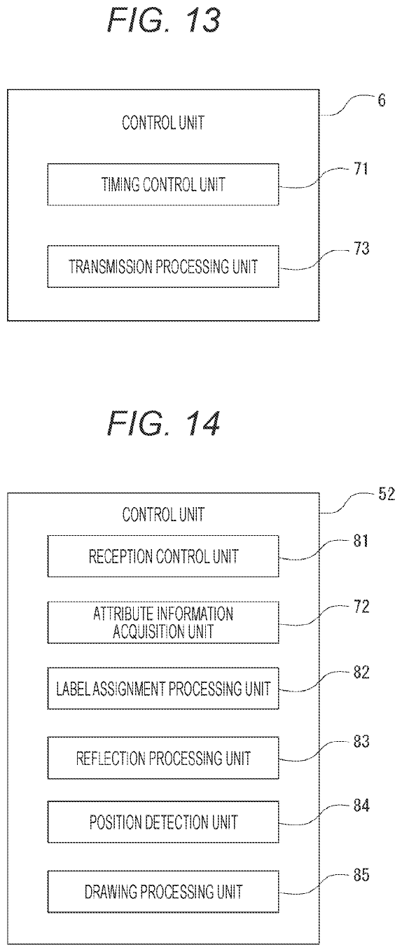

FIG. 13 is a block diagram illustrating functions to be implemented by a control unit 6 of the stylus 1B, and FIG. 14 is a block diagram illustrating functions to be implemented by a control unit 52 of the tablet terminal TB. Note that functions same as the functions described above are denoted by the same reference numerals, and descriptions thereof are omitted.

The control unit 6 of the stylus 1B has functions as a timing control unit 71 and a transmission processing unit 73. The timing control unit 71 controls timing for obtaining attribute information of the object OB.

The transmission processing unit 73 performs processing of transmitting, to the tablet terminal TB, pixel signals output from a first sensor 5A and a second sensor 5B. Note that, at the time of transmission, the pixel signals may be converted into a data format suitable for the transmission.

The control unit 52 of the tablet terminal TB has functions as a reception processing unit 81, an attribute information acquisition processing unit 72, a label assignment processing unit 82, a reflection processing unit 83, a position detection unit 84, and a drawing processing unit 85.

The reception processing unit 81 performs processing of receiving information regarding the pixel signals transmitted by the processing of the transmission processing unit 73 of the stylus 1B.

The attribute information acquisition processing unit 72 obtains color information and unevenness information as the attribute information on the basis of the information regarding the pixel signals. Note that the attribute information acquisition processing unit 72 may obtain distance information as in the second embodiment.

The label assignment processing unit 82 compares the attribute information obtained by the attribute information acquisition processing with characteristics of each label, thereby specifying what kind of object the object OB is and performing labeling.

The label referred to here is for specifying and classifying the object OB to be subject to attribute extraction, such as “apple”, “orange”, “dog”, “cat”, or the like. Furthermore, labels such as “apple calyx”, “upper part of apple”, “lower part of apple”, and the like may be prepared in a more detailed manner.

Note that the label assignment processing may be carried out by the control unit 6 performing inference using an artificial intelligence (AI) model or the like obtained by machine learning, or a label selected by a user may be assigned. That is, the label assignment processing may be performed automatically or manually.

Note that the AI model to be used for the label assignment processing may be obtained by using, for example, a data set in which a polarization image and a label are paired as training data. Note that the AI model may be obtained by unsupervised learning.

The reflection processing unit 83 performs processing of reflecting the attribute information selected on the basis of the label assigned to the object OB in a drawing line attribute or a painting attribute. That is, general attribute information for each label is stored in a storage unit 53, and the reflection processing unit 83 performs processing of obtaining the attribute information from the storage unit 53 using label information as a search key and reflecting the attribute information in the attribute regarding the drawing.

The position detection unit 84 performs processing of detecting a position of the pen tip of the stylus 1B on a display unit DP. This processing is performed by, for example, detecting a change in capacitance.

The drawing processing unit 85 performs processing of drawing a line having a set thickness, processing of filling a designated area with a set attribute, and the like according to the detected position of the pen tip of the stylus 1B. At this time, by applying the attribute obtained from the object OB to the attribute regarding the drawing, it becomes possible to perform drawing reproducing the color and texture of the object OB.

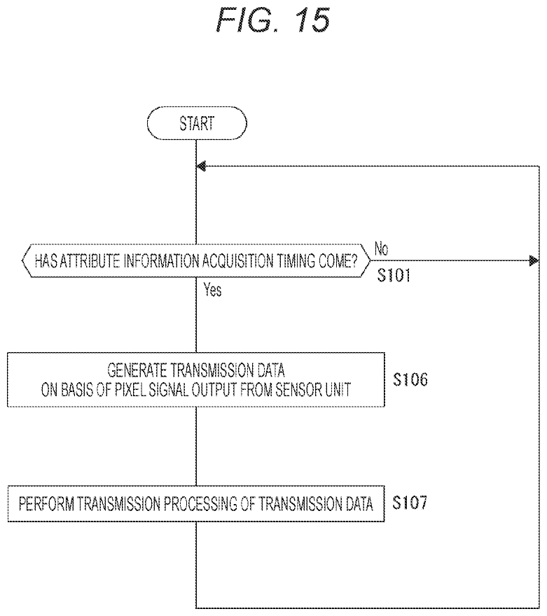

A flow of a process to be executed by the control unit 6 of the stylus 1B according to the third embodiment will be described with reference to FIG. 15.

In step S101, the control unit 6 determines whether or not the timing for obtaining the attribute information has come. In a case where the timing is not determined to have come, the control unit 6 performs the processing of step S101 again.

In a case where the timing for obtaining the attribute information is determined to have come, the control unit 6 generates transmission data on the basis of pixel signals output from the sensor unit 4 in step S106.

Subsequently, in step S107, the control unit 6 performs processing of transmitting the transmission data.

As a result, it becomes possible to obtain the attribute information and to assign a label on the side of the tablet terminal TB.

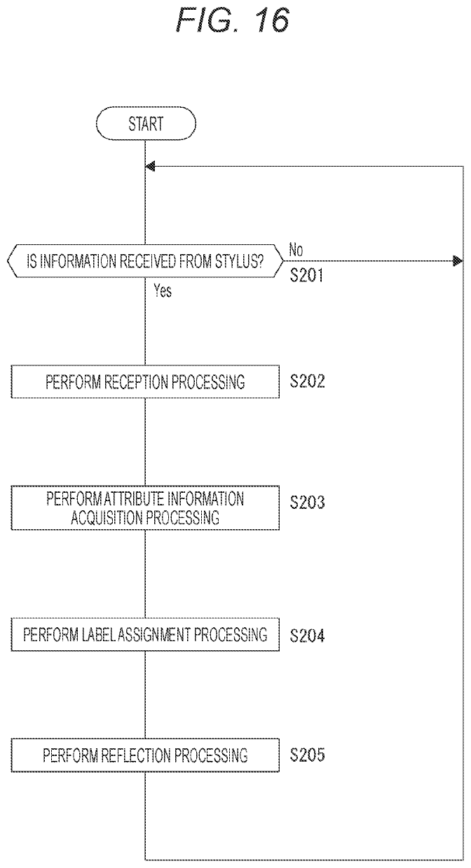

Next, a flow of a process to be executed by the control unit 52 of the tablet terminal TB will be described with reference to FIG. 16.

In step S201, the control unit 52 determines whether or not information has been received from the stylus 1B. In a case where the information is not determined to have been received, the control unit 52 executes the processing of step S201 again.

In a case where the information is determined to have been received, the control unit 52 performs reception processing in step S202. With this processing, data based on the pixel signal is received from the stylus 1B.

In step S203, the control unit 52 performs processing of obtaining the attribute information. In this processing, the color information and the unevenness information as the attribute information are obtained on the basis of the information regarding the pixel signals.

In step S204, the control unit 52 performs the label assignment processing.

In step S205, the control unit 52 performs processing of reflecting the attribute information corresponding to the assigned label in the drawing line and painting attribute information.

By the control unit 52 performing the series of processing illustrated in FIG. 16, the color information and the unevenness information obtained on the basis of the pixel signals obtained by the stylus 1B are reflected in the drawing line attribute information and the painting attribute information.

Note that the control unit 52 performs, in addition to the process illustrated in FIG. 16, processing of obtaining a coordinate position on the display unit DP in contact with the pen tip of the stylus 1B in parallel. Then, the control unit 52 performs various kinds of drawing according to the coordinate position.

While an exemplary case where the polarization sensor is provided as the second sensor 5B has been described in the present example, a ToF sensor 5Ba and a light emitting unit 10 may be provided in a similar manner to the second embodiment.

Furthermore, while an exemplary case where the control unit 52 of the tablet terminal TB includes the label assignment processing unit 82 has been described, the attribute information regarding the drawing may be set on the basis of the obtained unevenness information without assigning a label. For example, a shape of unevenness, a pitch of unevenness, a height difference of unevenness, and the like may be specified as the unevenness information, and the attribute regarding the drawing may be set on the basis of the specified information.

With this arrangement, for example, it becomes possible to set different attribute information according to a difference in variety or a difference in ripeness even if the object OB belongs to “apple”.

### 6. Fourth Embodiment

A stylus 1C according to a fourth embodiment includes a multispectral sensor 5Ac as a first sensor 5A, and a second sensor 5B as a polarization sensor.

The multispectral sensor 5Ac is capable of improving color reproducibility as compared with an RGB sensor.

Arrangement of the multispectral sensor 5Ac and the second sensor 5B is configured in a similar manner to FIG. 3. In addition, configurations of the stylus 1C and a tablet terminal TB are similar to the configurations in FIG. 5.

Moreover, a functional configuration of the control unit 6 of the stylus 1C is similar to that of FIG. 7.

Note that an attribute information acquisition processing unit 72 obtains color information and unevenness information as attribute information on the basis of pixel signals output from the multispectral sensor 5Ac and the second sensor 5B.

At this time, as for the color information, the multispectral sensor 5Ac is used so that information with reproducibility higher than that of the RGB sensor may be obtained.

In addition, as for the unevenness information, not only the output from the polarization sensor but also the output from the multispectral sensor 5Ac is used.

Specifically, not only unevenness of an object OB is detected using a pixel signal output from the polarization sensor, but also a material of the object OB is specified on the basis of polarization information output from the multispectral sensor 5Ac.

By using both the polarization sensor and the multispectral sensor 5Ac, it becomes possible to obtain texture information of the object OB more accurately.

Note that, as in the second embodiment, the stylus 1C may include a ToF sensor 5Ba and a light emitting unit 10 instead of the polarization sensor. Furthermore, the stylus 1C may include the light emitting unit 10 without including the ToF sensor 5Ba.

### 7. Fifth Embodiment

A stylus 1D according to a fifth embodiment includes a multispectral AI sensor 5Ad as a first sensor 5A, and a second sensor 5B as a polarization sensor.

Arrangement of the multispectral AI sensor 5Ad and the polarization sensor is configured in a similar manner to FIG. 3. In addition, configurations of the stylus 1D and a tablet terminal TB are similar to the configurations in FIG. 5.

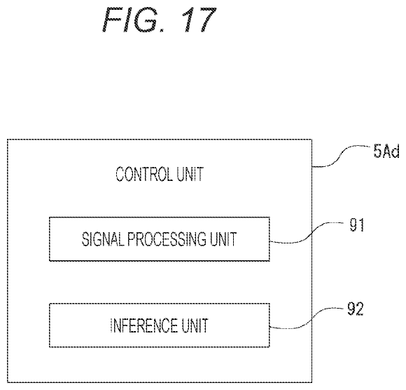

As illustrated in FIG. 17, the multispectral AI sensor 5Ad of the stylus 1D has functions as a signal processing unit 91 and an inference unit 92.

The signal processing unit 91 performs various types of correction processing and image processing on a signal output from a pixel array included in the multispectral AI sensor 5Ad. Processing of those types is what is called pre-processing, post-processing, or the like.

The inference unit 92 is capable of estimating color information more accurately than the RGB sensor by performing inference processing using an AI model on a pixel signal (image signal) output from the signal processing unit 91.

The AI model used here may be obtained by, for example, performing machine learning using, as training data, a data set in which an image from which color information is extractable such as an RGB image, a multispectral image, or the like and color information or label information such as “apple” are paired. Note that the AI model may be obtained by performing unsupervised learning.

Furthermore, the material of the object OB may be estimated on the basis of the signal output from the pixel array of the multispectral AI sensor 5Ad. Therefore, the inference unit 92 may estimate information regarding texture of the object OB using both the estimated material information and polarization information output from the polarization sensor.

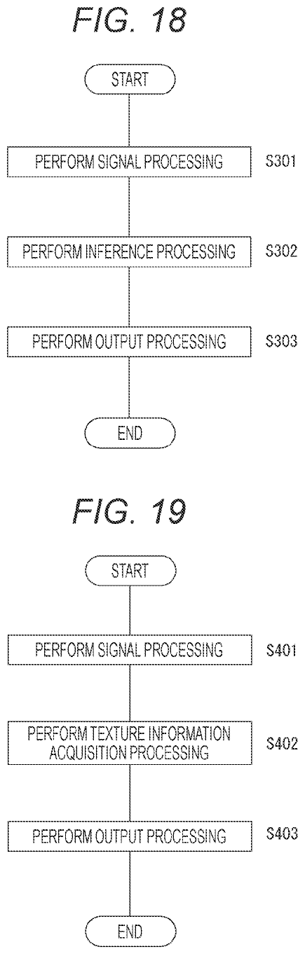

A flow of a process to be executed by the multispectral AI sensor 5Ad will be described with reference to FIG. 18.

Note that the multispectral AI sensor 5Ad in the present example functions as a computer device including a CPU, a GPU, a ROM, a RAM, and the like. In addition, the control unit such as the CPU, GPU, or the like of the multispectral AI sensor 5Ad is capable of executing a series of processing illustrated in FIG. 18.

That is, in step S301, the control unit of the multispectral AI sensor 5Ad executes signal processing, which is what is called pre-processing or post-processing.

In step S302, the control unit of the multispectral AI sensor 5Ad performs inference processing. The color information is estimated by this inference processing.

In step S303, the control unit of the multispectral AI sensor 5Ad outputs the estimated color information.

The series of processing illustrated in FIG. 18 is executed by the control unit of the multispectral AI sensor 5Ad, and a series of processing illustrated in FIG. 19 is executed by the polarization sensor as the second sensor 5B.

Specifically, in step S401, a processing unit of the polarization sensor executes signal processing as pre-processing or post-processing.

Subsequently, in step S402, the processing unit of the polarization sensor performs texture information acquisition processing. The texture information acquisition processing obtains unevenness information as the information regarding the texture of the object OB.

Finally, in step S403, the processing unit of the polarization sensor executes processing of outputting the unevenness information.

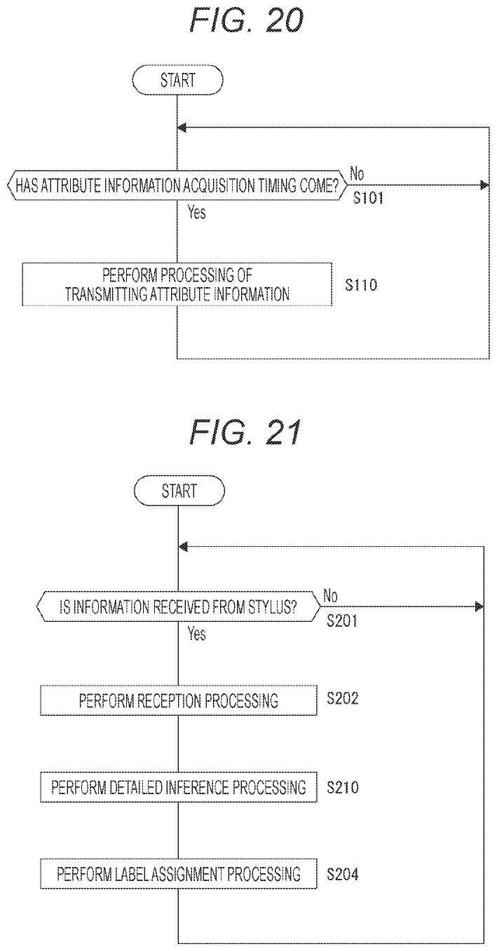

A control unit 6 of the stylus 1D that has received the information output from the multispectral AI sensor 5Ad and the second sensor 5B as the polarization sensor executes a series of processing illustrated in FIG. 20.

Specifically, in step S101, the control unit 6 determines whether or not timing for obtaining attribute information has come.

The control unit 6 executes the processing of step S101 until the timing for obtaining the attribute information is determined to have come.

In a case where the timing for obtaining the attribute information is determined to have come, in step S110, the control unit 6 executes processing of collectively transmitting, to the tablet terminal TB, the inference result received from the multispectral AI sensor 5Ad and the unevenness information received from the second sensor 5B as the attribute information of the object OB.

A control unit 52 of the tablet terminal TB that has received the attribute information executes a series of processing illustrated in FIG. 21.

Specifically, in step S201, the control unit 52 determines whether or not information has been received from the stylus 1D. In a case where the information is not determined to have been received, the control unit 52 performs the processing of step S201 again.

In a case where the information is determined to have been received, the control unit 52 performs processing of receiving the attribute information in step S202.

In step S210, the control unit 52 executes detailed inference processing using the AI model. This processing uses a high-performance AI model using computer resources more abundant than those mounted on the sensor to perform highly accurate inference processing. According to this processing, it becomes possible to improve the accuracy of the attribute information, such as the color information, the unevenness information, and the like.

Note that the high-performance AI model indicates an AI model having a larger number of layers and nodes.

In step S204, the control unit 52 performs processing of assigning a label on the basis of the highly accurate attribute information.

### 8. Sixth Embodiment

In the example described above, the stylus 1 (1A, 1B, 1C, 1D) includes two sensors of the first sensor 5A and the second sensor 5B.

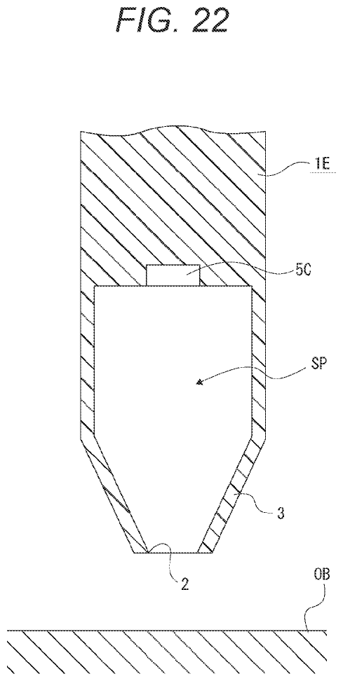

A stylus 1E according to a sixth embodiment includes one sensor 5C (see FIG. 22). The one sensor 5C may be a sensor in which a function of obtaining color information and a function of obtaining information regarding texture are integrated, or may be capable of obtaining either one of the attribute information.

First, the sensor 5C capable of obtaining both the color information and the information regarding texture will be described.

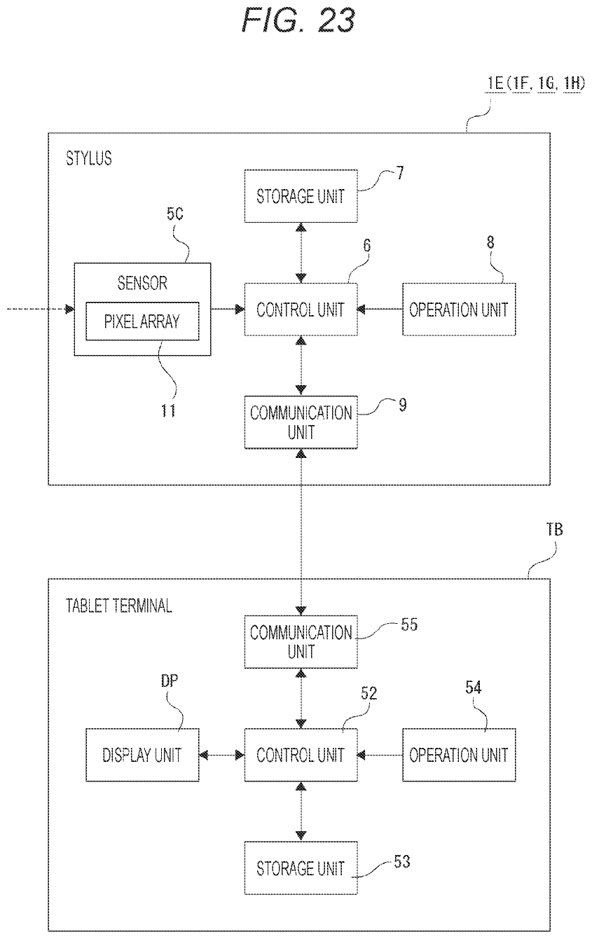

As illustrated in FIG. 23, the sensor 5C includes a pixel array 11 in which pixels are two-dimensionally arranged.

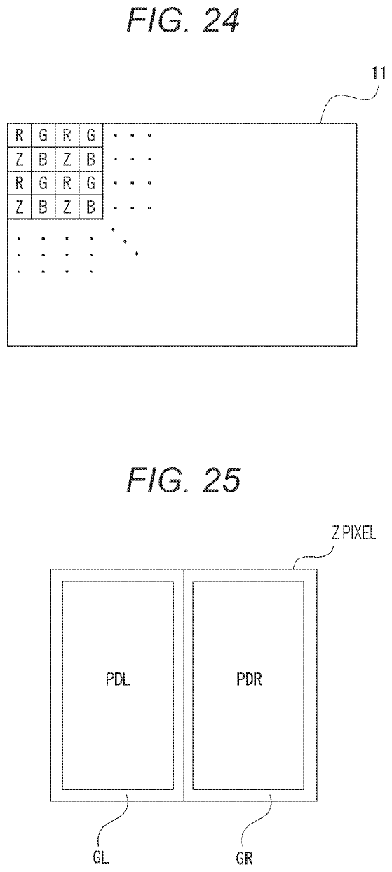

The pixel array 11 includes, for example, a Z pixel in addition to an R pixel, a G pixel, and a B pixel (see FIG. 24).

The Z pixel is a pixel different from the R pixel, the G pixel, and the B pixel, and is, for example, a divided pixel or a light-shielding pixel capable of obtaining distance information, or a polarization pixel capable of obtaining polarization information.

FIG. 25 illustrates an example of the Z pixel as a divided pixel.

In the Z pixel as a divided pixel, a left pixel GL having a left side light-receiving area PDL and a right pixel GR having a right side light-receiving area PDR are formed adjacent to each other.

A defocus amount may be calculated by calculating a phase difference between the left pixel GL and the right pixel GR, and a distance to an object OB therefrom may be calculated.

In the Z pixel as the light-shielding pixel, a first aspect including a combination of a light-shielding pixel GS in which the right half of the light-receiving area is shielded and the left pixel GL in which the left half of the light-receiving area is light-receptive and a second aspect including a combination of the right pixel GR in which the right half of the light-receiving area is light-receptive and the light-shielding pixel GS in which the left half of the light-receiving area is shielded are evenly arranged on the pixel array 11.

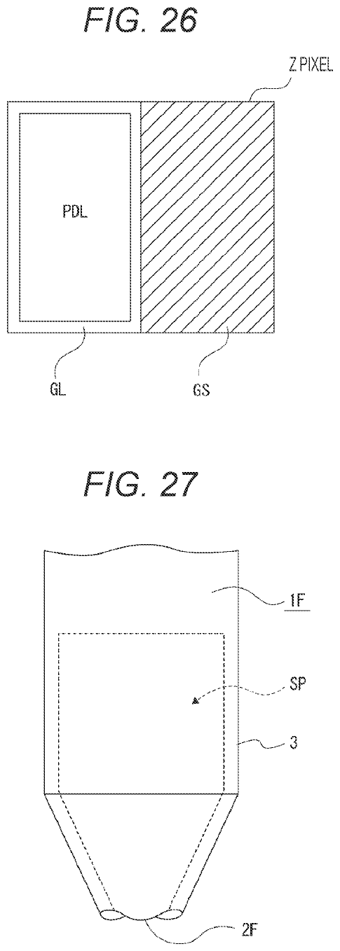

FIG. 26 illustrates an example of the Z pixel as the light-shielding pixel of the first aspect, and the Z pixel as the light-shielding pixel of the second aspect is obtained by arranging the right pixel GR at the position of the light-shielding pixel GS in FIG. 26 and arranging the light-shielding pixel GS in the left pixel GL.

By calculating a phase difference between a signal output from the light-shielding pixel of the first aspect and a signal output from the light-shielding pixel of the second aspect, it becomes possible to calculate a defocus amount in a similar manner to the divided pixel.

Furthermore, although illustration is omitted, the Z pixel may be a polarization pixel including a polarizer.

Note that the Z pixel may be configured such that both the color information and the information regarding texture can be obtained from one Z pixel by adopting a pixel structure in which a layer capable of obtaining a general RGB signal and a layer for obtaining the information regarding texture are laminated.

In this manner, the color information and the information regarding texture may be obtained using one sensor 5C including the Z pixel.

Furthermore, in this case, it is also possible to impart a function for obtaining texture information as the Z pixel to each pixel in the RGGB array (Bayer layout).

Examples of another aspect of the sensor 5C include a multispectral sensor.

Since the multispectral sensor is capable of estimating (specifying) a material of the object OB, it becomes possible to obtain both the color information and the information regarding texture.

Alternatively, the sensor 5C may be an AI sensor as still another aspect.

The AI sensor is capable of obtaining various types of attribute information of the object OB by performing estimation processing using an AI model with a pixel signal output from the pixel array as an input.

Note that the sensor 5C may include a polarization sensor or a ToF sensor capable of obtaining only the information regarding texture.

In this case, a control unit 6 of the stylus 1E or a control unit 52 of a tablet terminal TB may add color information. With this arrangement, it becomes possible to perform drawing to which color information different from reality is added while reflecting the texture of the object OB. In addition, the color information may be designated by a user.

Functions of the sensor 5C according to the sixth embodiment may be similar to any of the sensors according to other embodiments described above.

In addition, functions of the stylus 1E and the tablet terminal TB may be similar to the modes of other embodiments described above.

Moreover, processes to be executed by a control unit of the sensor 5C, the control unit 6 of the stylus 1E, and the control unit 52 of the tablet terminal TB may be in any mode of the individual examples described above. For example, the control unit 6 of the stylus 1E may be configured to obtain color information and unevenness information to transmit them to the tablet terminal TB, or the tablet terminal TB may be configured to obtain the color information and the unevenness information.

### 9. Variations

It has been described that the stylus 1 (1A, 1B, 1C, 1D, 1E) includes the light emitting unit 10 so that various images of the object OB may be favorably obtained even in a case where the pen tip is close to the object OB to a maximum extent.

In addition to the light emitting unit 10, the stylus 1 may include a configuration capable of favorably obtaining various images of the object OB.

An example is illustrated in FIG. 27.

In an opening 2F formed at a pen tip of a stylus 1F, concave portions and convex portions are alternately formed in a circumferential direction.

With this arrangement, external light enters an internal space SP from the concave portion of the opening 2F even if the opening 2F is pressed against the object OB, whereby possibility of failing to appropriately obtain attribute information due to an insufficient light amount may be reduced.

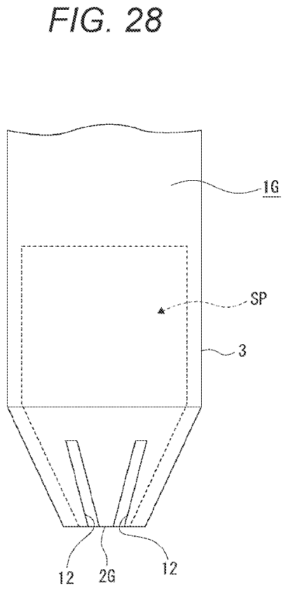

Furthermore, another example is illustrated in FIG. 28.

A plurality of slits 12 is formed at a pen tip of a stylus 1G while spaced apart from each other in a circumferential direction.

Even with such a structure, the external light enters the internal space SP from the slits 12 in the opening 2F, whereby the insufficient light amount at the time of image acquisition may be resolved.

Note that, in a case where a ToF sensor is included, it is preferable to adopt a configuration separately including the light emitting unit 10 even if the structure illustrated in FIG. 27 or FIG. 28 is provided.

The stylus 1 may include a condenser lens 13.

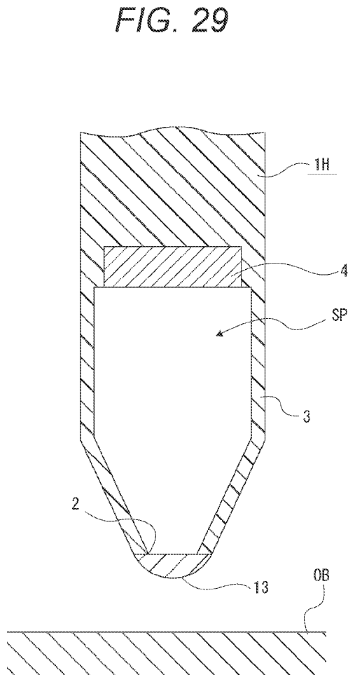

Specifically, in a stylus 1H illustrated in FIG. 29, the condenser lens 13 is attached to close an opening 2 of a pen tip.

Configurations other than the attachment of the condenser lens 13 to the opening 2 may adopt the configurations of the individual examples described above.

Since the condenser lens 13 is attached to the opening 2, light incident on the internal space SP through the opening 2 may be efficiently condensed on a sensor of a sensor unit 4.

A personal computer (PC) or a smartphone may be used as a substitute for the tablet terminal TB described above.

### 10. Conclusion

As described in the individual examples described above, the stylus 1 (1A, 1B, 1C, 1D, 1E, 1F, 1G, 1H) includes the first sensor 5A (multispectral sensor 5Ac) having sensitivity to visible light, and the second sensor 5B (ToF sensor 5Ba) that obtains information regarding a shape of the object OB.

With this arrangement, it becomes possible to obtain information regarding not only color but also texture of an object OB.

By reflecting such information in the attribute information regarding the drawing, it becomes possible to easily draw a picture reproducing both the color and the texture.

In addition, with the information regarding the texture reflected, a damaged texture, a used metallic texture, a worn metallic texture, or the like may not be reproduced only by color. By obtaining the information regarding the texture of the object OB as in the present configuration, it becomes possible to draw a line or painting closer to the object OB.

As described above, the second sensor 5B of the stylus 1 (1A, 1B, 1C, 1D, 1F, 1G, 1H) may be capable of obtaining the information regarding the unevenness of the object OB.

The information regarding the unevenness may be information obtained from the distance information to the object OB, the polarization information regarding the object OB, or the information regarding the material of the object OB, which is information that may estimate unevenness texture.

By obtaining the information regarding the unevenness of the object OB, it becomes possible to draw a picture in which the texture is reproduced.

The second sensor 5B (ToF sensor 5Ba) of the stylus 1 (1A, 1B, 1C, 1D, 1F, 1G, 1H) or the like may obtain the information regarding the unevenness of the object OB by obtaining the distance information regarding the object OB.

Since the pitch, the height difference, and the shape of unevenness of the object OB may be specified from the distance information, it becomes possible to reproduce the texture.

The stylus 1 (1A, 1B, 1C, 1D, 1F, 1G, 1H) or the like may include the light emitting unit 10 that emits light (e.g., IR light), and the second sensor 5B may be the ToF sensor 5Ba.

The ToF sensor 5Ba and the light emitting unit 10 are included and are controlled in synchronization with each other, whereby the distance information regarding the object OB may be appropriately obtained.

As described with reference to FIGS. 3, 4, and the like, the second sensor 5B in the stylus 1 (1B, 1C, 1D, 1F, 1G, 1H) may be the polarization sensor.

Since the orientation of the surface with respect to the object OB may be obtained by the polarization sensor, it becomes possible to obtain the unevenness information of the object OB.

As described with reference to FIGS. 3 and 4, the first sensor 5A in the stylus 1 (1A, 1B, 1C, 1D, 1F, 1G, 1H) may be a sensor that obtains the color information of the object OB.

By obtaining not only the information regarding the texture but also the color information of the object OB, it becomes possible to easily draw a picture appropriately resembling the object OB.

As described with reference to FIGS. 3 and 4, the first sensor 5A in the stylus 1 (1A, 1B, 1F, 1G, 1H) may be the RGB sensor.

By using the RGB sensor, it becomes possible to obtain the color information regarding the object OB.

As described with reference to FIGS. 3, 4, and the like, in the stylus 1 (1B, 1C, 1D, 1F, 1G, 1H), the first sensor 5A may be the multispectral sensor 5Ac, and the second sensor 5B may be the polarization sensor.

The unevenness information regarding the object OB may be obtained by the polarization sensor as the second sensor 5B. In addition, the multispectral sensor 5Ac is capable of obtaining the information that may specify the material of the object OB, whereby the accuracy of the unevenness information of the object OB may be further improved.

Therefore, it becomes possible to obtain the information regarding the texture of the object OB more accurately.

As described in the variations, the stylus 1H may include the condenser lens 13 that condenses incident light on the first sensor 5A or the second sensor 5B.

With this arrangement, the light amount of the incident light that enters the sensor 5 may be improved, which may resolve the insufficient light amount at the time of imaging by the sensor 5.

Therefore, it becomes possible to extract more accurate attribute information (color information and information regarding texture) regarding the object OB.

As described in the variations, the styluses 1F and 1G may have the incident light capturing structure (structure of opening 2F or slit 12) that increases the light amount of the light incident on the first sensor 5A or the second sensor 5B.

With the styluses 1F and 1G having the incident light capturing structure, it becomes possible to resolve the insufficient light amount at the time of imaging by the sensor 5. Furthermore, in a case where the insufficient light amount may be resolved without providing the light emitting unit 10, it becomes possible to reduce the number of components and cost.

As described in the variations, the slit 12 may be formed as the incident light capturing structure in the stylus 1G.

The slit 12 may resolve the insufficient light amount at the time of imaging by the sensor 5.

As described with reference to FIG. 7 and the like, the stylus 1 (1A, 1C, 1D, 1E, 1F, 1G, 1H) may include the attribute information acquisition processing unit 72 that extracts the drawing attribute information according to outputs of the first sensor 5A and the second sensor 5B, and the transmission processing unit 73 that transmits the extracted attribute information to another information processing device (tablet terminal TB, etc.).

With this arrangement, it becomes possible to draw a picture reflecting the texture and the like of the object OB while reducing the processing load in the another information processing device such as the tablet terminal TB.

As described above, the stylus 1 (1A, 1B, 1C, 1D, 1E, 1F, 1G, 1H) may include the texture acquisition unit (second sensor 5B) that obtains the information regarding the texture of the object OB.

Note that the second sensor 5B and the control unit 52 of the tablet terminal TB may be included in the texture acquisition unit in a case where the tablet terminal TB executes the processing of obtaining the information regarding the texture.

With this arrangement, it becomes possible to obtain information regarding not only color but also texture of an object OB.

By reflecting such information in the attribute information regarding the drawing, it becomes possible to easily draw a picture reproducing both the color and the texture.

As described in the sixth embodiment, the stylus 1E may include the sensor 5C in which the function as the texture acquisition unit (second sensor 5B) and the function as the color information acquisition unit (first sensor 5A) that obtains the color information of the object OB are integrated.

By including one sensor 5C in which the functions of the first sensor 5A and the second sensor 5B are integrated, it becomes possible to suitably arrange the sensor.

In addition, by integrating the functions into the one sensor 5C, it becomes possible to reduce the cost.

As described in the sixth embodiment, the sensor 5C in which the functions provided in the stylus 1E are integrated may be configured such that a portion for obtaining the color information and a portion for obtaining the information regarding the texture are laminated.

With this arrangement, both the color information and the information regarding the texture may be obtained in each pixel, whereby highly dense information regarding the color information and the texture may be obtained.

As described in the sixth embodiment, the sensor 5C in which the functions provided in the stylus 1E are integrated may be the multispectral sensor.

With this arrangement, it becomes possible to obtain both the color information and the information regarding the texture.

As described in the fifth embodiment, the texture acquisition unit (second sensor 5B) in the stylus 1D may be the AI sensor (multispectral AI sensor 5Ad) that performs inference using the AI model.

By using the AI model obtained by appropriate learning in the AI sensor, it becomes possible to obtain information with accuracy higher than that of the information regarding the texture obtained by simply comparing the sensor output with the stored information.

As described in the second embodiment and the like, the stylus 1 (1A, 1B, 1C, 1D, 1E, 1F, 1G, 1H) may include the light emitting unit 10 that emits light.

Furthermore, the light emitting unit 10 may be capable of emitting IR light in accordance with the ToF sensor 5Ba that receives the IR light, or may be capable of emitting visible light to resolve the insufficient light amount of a sensor capable of obtaining the color information, such as the RGB sensor.

By the light emitting unit 10 included in the stylus 1, it becomes possible to appropriately obtain the distance information and to appropriately obtain the color information.

Note that the effects described in the present specification are merely examples and are not limited, and other effects may be exerted.

Furthermore, the individual examples described above may be combined in any way, and the various functions and effects described above may be obtained even in a case where various combinations are used.

### 11. Present Technology

The present technology may also adopt the following configurations.

(1)

A stylus including:
a first sensor that has sensitivity to visible light; and
a second sensor that obtains information regarding a shape of an object.
   (2)

The stylus according to (1) described above, in which the second sensor is capable of obtaining information regarding unevenness of the object.

(3)

The stylus according to (2) described above, in which the second sensor obtains distance information regarding the object to obtain the information regarding the unevenness of the object.

(4)

The stylus according to (3) described above, further including:
a light emitting unit that emits light, in which the second sensor includes a ToF sensor.
   (5)

The stylus according to (2) described above, in which the second sensor includes a polarization sensor.

(6)

The stylus according to any one of (1) to (5) described above, in which
the first sensor includes a sensor that obtains color information of the object.
   (7)

The stylus according to claim 6) described above, in which the first sensor includes an RGB sensor.

(8)

The stylus according to (1) or (2) described above, in which the first sensor includes a multispectral sensor, and the second sensor includes a polarization sensor.

(9)

The stylus according to any one of (1) to (8) described above, further including:
a condenser lens that condenses incident light on the first sensor or the second sensor.
   (10)

The stylus according to any one of (1) to (9) described above, in which the stylus has an incident light capturing structure that increases a light amount of light incident on the first sensor or the second sensor.

(11) The stylus according to (10) described above, in which a slit is formed as the incident light capturing structure.
(12)

The stylus according to any one of (1) to (11) described above, further including:
an attribute information acquisition processing unit that extracts drawing attribute information according to an output of the first sensor and the second sensor; and a transmission processing unit that transmits the extracted attribute information to another information processing device.
   (13)

A stylus including:
a texture acquisition unit that obtains information regarding texture of an object.
   (14)

The stylus according to (13) described above, further including:
a sensor in which a function as the texture acquisition unit and a function as a color information acquisition unit that obtains color information of the object are integrated.
   (15)

The stylus according to (14) described above, in which a portion that obtains the color information and a portion that obtains the information regarding the texture are laminated in the sensor in which the functions are integrated.

(16)

The stylus according to (14) described above, in which the sensor in which the functions are integrated includes a multispectral sensor.

(17)

The stylus according to any one of (13) to (16) described above, in which the texture acquisition unit includes an AI sensor that performs inference using an AI model.

(18)

The stylus according to any one of (13) to (17) described above, further including:
a light emitting unit that emits light.

### REFERENCE SIGNS LIST

1, 1A, 1B, 1C, 1D, 1E, 1F, 1G, 1H Stylus
5 Sensor
5A First sensor unit
5Ac Multispectral sensor
5B Second sensor
5Ba TOF sensor
5C Sensor
10 Light emitting unit
12 Slit (incident light capturing structure)
OB Object
TB Tablet terminal (another information processing device)

1. A stylus comprising:
a first sensor that has sensitivity to visible light; and
a second sensor that obtains information regarding a shape of an object.

2. The stylus according to claim 1, wherein
the second sensor is capable of obtaining information regarding unevenness of the object.

3. The stylus according to claim 2, wherein
the second sensor obtains distance information regarding the object to obtain the information regarding the unevenness of the object.

4. The stylus according to claim 3, further comprising:
a light emitting unit that emits light, wherein
the second sensor includes a ToF sensor.

5. The stylus according to claim 2, wherein
the second sensor includes a polarization sensor.

6. The stylus according to claim 1, wherein
the first sensor includes a sensor that obtains color information of the object.

7. The stylus according to claim 6, wherein
the first sensor includes an RGB sensor.

8. The stylus according to claim 1, wherein
the first sensor includes a multispectral sensor, and
the second sensor includes a polarization sensor.

9. The stylus according to claim 1, further comprising:
a condenser lens that condenses incident light on the first sensor or the second sensor.

10. The stylus according to claim 1, wherein
the stylus has an incident light capturing structure that increases a light amount of light incident on the first sensor or the second sensor.

11. The stylus according to claim 10, wherein
a slit is formed as the incident light capturing structure.

12. The stylus according to claim 1, further comprising:
an attribute information acquisition processing unit that extracts drawing attribute information according to an output of the first sensor and the second sensor; and
a transmission processing unit that transmits the extracted attribute information to another information processing device.

13. A stylus comprising:
a texture acquisition unit that obtains information regarding texture of an object.

14. The stylus according to claim 13, further comprising:
a sensor in which a function as the texture acquisition unit and a function as a color information acquisition unit that obtains color information of the object are integrated.

15. The stylus according to claim 14, wherein
a portion that obtains the color information and a portion that obtains the information regarding the texture are laminated in the sensor in which the functions are integrated.

16. The stylus according to claim 14, wherein
the sensor in which the functions are integrated includes a multispectral sensor.

17. The stylus according to claim 13, wherein
the texture acquisition unit includes an AI sensor that performs inference using an AI model.

18. The stylus according to claim 13, further comprising:
a light emitting unit that emits light.
